(19) United States
(12) Patent Application Publication
(10) Pub. No.: US 2024/0307849 A1
(43) Pub. Date: Sep. 19, 2024

(54) GUANIDINE AND MIXED-BASE FUNCTIONALIZED POLYMERS

(71) Applicants: ExxonMobil Technology and Engineering Company, Annandale, NJ (US); GEORGIA TECH RESEARCH CORPORATION, Atlanta, GA (US)

(72) Inventors: Lisa Saunders Baugh, Ringoes, NJ (US); Simon C. Weston, Annandale, NJ (US); David C. Calabro, Bridgewater, NJ (US); M.G. Finn, Atlanta, GA (US); Saona Seth, Tezpur (IN); Srinivas Tekkam, Chelmsford, MA (US); Ryan P. Lively, Atlanta, GA (US); Fengyi Zhang, Missouri City, TX (US); Ankana Roy, Atlanta, GA (US); Hannah E. Holmes, Atlanta, GA (US)

(21) Appl. No.: 18/185,113

(22) Filed: Mar. 16, 2023

(51) Int. Cl. B01J 20/26; C08J 7/16; C08L 71/12

(52) U.S. Cl. CPC B01J 20/265; C08J 7/16; C08L 71/126; B01J 2220/44

(57) ABSTRACT

Functionalized polymer compositions are provided that can have beneficial properties for CO₂ sorption and/or desorption. The functionalized polymer compositions can be based on polymers of intrinsic microporosity. The polymers of intrinsic microporosity can then be at least partially reacted to form polymers functionalized with guanidine and/or amidine derivatives where at least a portion of the polymeric repeat units have a substituent that includes a guanidine derivative and/or amidine derivative as a functional group. Optionally, the functionalized polymers of intrinsic microporosity can be further reacted in order to further modify the guanidine derivative and/or amidine derivative that is substituted at one or more locations of a polymeric repeat unit.

### FIELD

Polymeric sorbent compositions are provided based on guanidine functionalized polymers of intrinsic microporosity.

### BACKGROUND

Mitigation of CO₂ emissions from various types of CO₂ sources (both industrial and small-scale) is an area of ongoing interest. One type of strategy for mitigation of CO₂ emissions is to use an adsorbent or absorbent to remove CO₂ from a potential emission gas flow, and then desorb the CO₂ as part of a stream that can be processed to reduce, minimize, or eliminate the release of CO₂ into the atmosphere.

One difficulty with developing adsorbents for CO₂ removal from gas streams is that many streams where CO₂ removal would be desirable correspond to streams having relatively low concentrations of CO₂. For example, exhaust streams from natural gas-fired plants for electric power generation typically contain roughly 4-5 vol % or less of CO₂. Similar difficulties are present for direct air capture methods, where CO₂ concentrations can be still lower. Thus, it would be desirable to have adsorbents that can effectively adsorb CO₂ from such relatively dilute streams. Additionally, it would further be desirable if such adsorbents can also release the CO₂ by exposing the adsorbent to desorption conditions that can be achieved with relatively modest expenditure of energy.

Polymers of intrinsic microporosity (PIMs) are porous organic polymers based on rigid and contorted macromolecular chains. The rigid and contorted macromolecular chains do not efficiently pack in the solid state, resulting in high porosity. Some examples of functionalized polymers of intrinsic microporosity are described in an article by Mason et al. titled “Polymers of Intrinsic Microporosity Incorporating Thioamide Functionality: Preparation and Gas Transport Properties” (Macromolecules, Vol. 44, pp. 6471 (2011)).

U.S. Pat. No. 8,715,397 describes a mixed amine and non-nucleophilic base CO₂ scrubbing process for improved adsorption at increased temperatures.

U.S. Pat. No. 9,034,288 describes a CO₂ scrubbing process including an alkanolamine CO₂ sorbent in combination with a non-nucleophilic base.

A journal article by Jue et al. describes synthesis of PIM-1 (Macromolecules 2015, 48 (16), 5780-5790).

A journal article by Mason et al. describes synthesis of PIM-1, as well as synthesis of PIM-1-amine from PIM-1 (Macromolecules 2014, 47, 1021-1029).

A journal article by Alkhabbaz et al. describes impregnation of guanidylated polyallylamine into silica mesocellular foam (Fuel 2014 121 79-85).

### SUMMARY

In an aspect, a composition is provided corresponding to a polymer including repeat units having a backbone structure of a polymer of intrinsic microporosity, wherein at least a portion of the repeat units have a substituent attached to the backbone structure corresponding to a guanidine derivative and/or an amidine derivative, the guanidine derivative optionally being a guanidinyl functional group and/or the amidine derivative optionally being an amidinyl functional group.

In another aspect, a method is provided for sorbing CO₂. The method includes exposing a polymer including repeat units having a backbone structure of a polymer of intrinsic microporosity to a gas phase environment containing CO₂, wherein at least a portion of the repeat units have a substituent attached to the backbone structure corresponding to a guanidine derivative and/or an amidine derivative.

### BRIEF DESCRIPTION OF THE DRAWINGS

FIG. 1 shows an example of a synthesis strategy for conversion of PIM-1 into guanidinyl-substituted PIM-1.

FIG. 2 shows a reaction scheme for conversion of Py-PIM into guanidinyl-substituted Py-PIM.

FIG. 3 shows various PIM repeat units that include guanidine derivatives as substituents.

FIG. 4 shows infrared (IR) spectroscopy plots for various PIMs.

FIG. 5 shows ¹³C nuclear magnetic resonance (NMR) spectroscopy plots for PIM-1 and PIM-1-amine (overlay, left; PIM-1-amine, right).

FIG. 6 shows IR spectroscopy plots for PIM-1-guanidine and PIM-1-amine.

FIG. 7 shows ¹³C nuclear magnetic resonance (NMR) spectroscopy plots for PIM-1-amine and PIM-1-guanidine.

FIG. 8 shows ¹³C nuclear magnetic resonance (NMR) spectroscopy plots for PIM-1-amine and PIM-1-guanidine fibers.

FIG. 9 shows CO₂ uptake mechanisms and products for various amines.

FIG. 10 shows formation of a “mixed base” guanidinium carbamate product from an amine, a guanidine, and CO₂.

FIG. 11 shows formation of guanidinium bicarbonate/carbonate products from a guanidine, CO₂, and water.

FIG. 12 shows dry CO₂ isothermal uptake for PIM-1 derivatives at 30° C.

FIG. 13 shows dry CO₂ isobars for PIM-1, PIM-1-amine, and PIM-1-guanidine.

FIG. 14 shows dry CO₂ isobars for PIM-1-guanidine and the hydrochloric acid polysalt of PIM-1-guanidine.

FIG. 15 shows a breakthrough desorption plot for CO₂- and H₂O-saturated PIM-1-guanidine.

FIG. 16 shows humid CO₂ thermogravimetric (TGA) uptake for PIM-1 derivatives at 30° C. (right plot is an expansion of left plot).

FIG. 17 shows humid H₂O thermogravimetric (TGA) uptake for PIM-1 derivatives at 30° C. (right plot is an expansion of left plot).

FIG. 18 shows a CO₂ breakthrough plot for PIM-1-guan.100 taken with 4.5% CO₂ in humid He (20% relative humidity at 35° C.

FIG. 19 shows results from thermogravimetric analysis of various samples.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, functionalized polymer compositions are provided that can have beneficial properties for CO₂ sorption and/or desorption. The functionalized polymer compositions can be based on polymers of intrinsic microporosity. The polymers of intrinsic microporosity can then be at least partially reacted to form polymers functionalized with guanidine derivatives and/or amidine derivatives, where at least a portion of the polymeric repeat units have a substituent that includes a guanidine derivative/amidine derivative as a functional group. Optionally, the guanidine-functionalized and/or amidine-functionalized polymers of intrinsic microporosity can be further reacted in order to further modify the guanidine derivative/amidine derivative that is substituted at one or more locations of a polymeric repeat unit. For example, guanidine derivative-substituted polymers of intrinsic microporosity can be formed. As another example, substituted polymers of intrinsic microporosity can be formed that include guanidine derivative substituents at only a portion of the locations that can potentially be functionalized. As still another example, amidine derivative-substituted polymers of intrinsic microporosity can be formed. As yet another example, substituted polymers of intrinsic microporosity can be formed that include amidine derivative substituents at only a portion of the locations that can potentially be functionalized. By varying the amount of guanidine derivative substitution and/or amidine derivative substitution present in the polymer, compositions with differing properties for CO₂ sorption and/or desorption can be formed.

Polymers of Intrinsic Microporosity (PIMs) are an emerging material of interest for gas separations. Spiro centers integrated into the polymer backbone prevent efficient packing and induce permanent microporosity in the polymer. This permanent microporosity can be advantageously used through impregnation of CO₂-philic molecules while still accommodating processability into a wide range of morphologies due to the solubility of the PIM in various common solvents.

In some aspects, it has been discovered that PIMs that include a nitrile group attached to the polymer backbone can be modified by replacing at least a portion of the nitrile functional groups with guanidine. For example, a first reaction can be used to convert substantially all of the nitrile groups to amines. At least a portion of the amines can then be converted to guanidine derivatives. In some aspects, the initial PIM can correspond to a PIM structure where the carbon of the nitrile group is bonded to an atom in a ring structure that forms part of the polymer backbone.

More generally, any convenient type of PIM that can be substituted to include a guanidine derivative without modifying the fused-ring backbone of the PIM can be used. Examples of PIM structures that can be modified to include guanidine derivatives are PIMs where a nitrogen-containing functional group is present in the PIM repeat unit and does not form part of the backbone structure (as defined below) of the PIM structural repeat units. Such functional groups can be susceptible to reaction using a variety of chemistries to convert a substituent location into a guanidine derivative. For example, the nitrile functional groups present in PIM-1 are attached to the backbone structure of a PIM-1 repeat unit via a bond between the carbon in the nitrile group and a carbon in a ring that forms part of the backbone structure. Such nitrile groups can, for example, first be converted into aminomethyl groups, and then converted into guanidine derivatives. As an example, it is noted that the nitrogen atom in the pyridine ring of the Py-PIM repeat unit is part of the backbone structure.

It has been discovered that functionalization of PIMs to include guanidine derivatives as substituents and/or amidine derivatives as substituents can reduce or minimize the surface area of the resulting functionalized PIMs. It has further been unexpectedly discovered that in spite of a reduction in the surface area of the resulting functionalized PIMs, substantial enhancements and/or modifications of CO₂ sorption/desorption activity can be achieved relative to the PIMs prior to incorporation of guanidine derivatives/amidine derivatives as substituents.

In some aspects, a substantial portion (such as up to substantially all) of the potential substituent sites can be converted to guanidine derivatives and/or amidine derivatives. This can result in a polymer with improved CO₂ adsorption properties. In other aspects, partial functionalization with guanidine derivatives and/or amidine derivatives can provide a structure having a mixture of functional groups with different levels of activity as either Lewis bases or Brønsted bases. The overall chemistry of CO₂ sorption in these materials requires both types of basicity. By controlling the degree of functionalization with guanidine derivatives and/or amidine derivatives, these two base functions can be de-coupled. This affords the possibility of fine-tuning the CO₂ sorption properties by varying the Lewis and Brønsted basicities independently. Since the nucleophilicity of the Lewis base directly affects the strength of the N—C bond that forms, it can be varied to alter the energy needed to break this bond to regenerate the free amine.

In such aspects, this can result in a polymer with improved CO₂ sorption properties. Additionally or alternately, this can result in a polymer with improved properties for CO₂ sorption from relatively dilute streams, such as CO₂-containing streams having a CO₂ concentration similar to the concentration found in exhaust streams from electric power plants that are fueled by combustion of natural gas.

Without being bound by any particular theory, it is believed that sorption behavior differences between guanidine- and amine-substituted PIM-1 samples represent differences in behavior based on the chemical nature of the heteroatomic functional substituent(s) present (amine, guanidine, or mixture thereof). Efficacy of the functional groups for CO₂ sorption can depend on basicity, steric hindrance, electronic character, the presence or absence of water vapor, and whether additional heteroatomic functionalities are present.

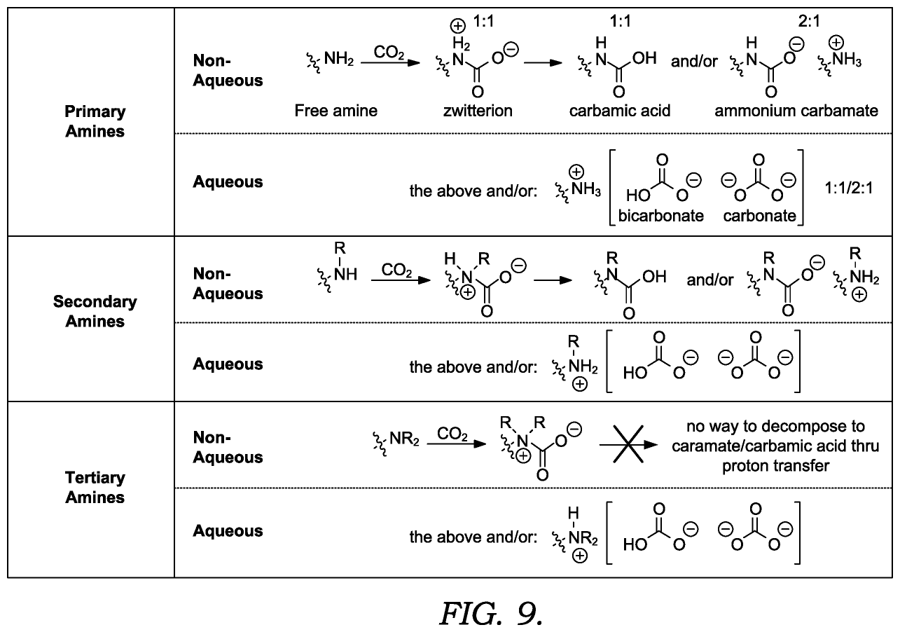

A simple amine can interact with a CO₂ molecule as either a nucleophilic Lewis base (electron donor) and/or a Brønsted base (proton acceptor). FIG. 9 shows commonly accepted simple reaction schemes, wherein “R” is an organic substituent not participating in the sorption chemistry. The amine first acts as a Lewis base/nucleophile and adds to the center carbon atom of CO₂ to form a zwitterion, which is in equilibrium with a neutral carbamic acid form. Proton transfer from the zwitterion amine to form the carbamic acid is only possible for primary and secondary amines. The carbamic acid product is then deprotonated by a second amine site (functioning as a Brønsted base) to form an ammonium carbamate. The second amine site may be a primary, secondary, or tertiary amine. If a mixture of reactive amines is present and able to react with CO₂, a product mixture may be formed. However, it is presumed that in the more prevalent ammonium carbamate products, the more Lewis basic (nucleophilic) amine will comprise the anionic carbamate component of the product, while the more highly Brønsted basic, less nucleophilic amine will form the ammonium component. Product distribution may depend on specific reaction variables, such as kinetic factors.

If water is present, the ammonium carbamate product(s) can further react to form ammonium bicarbonate(s). Diammonium carbonates may also be present depending on factors such as mixture pH.

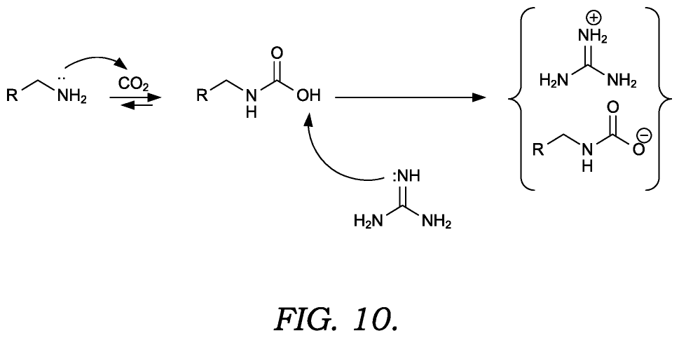

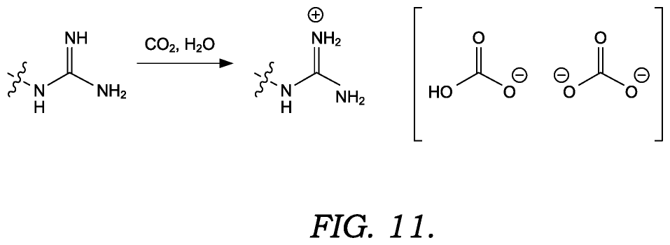

More complex nitrogenous functional groups, such as guanidines and amidines, can participate in this reaction sequence, with behavioral modifications consistent with structure. Guanidines have the general structure R—N(R′)—C(═NR″)—N(R′″)(R″″), wherein R is an organic substituent connected to the amidine through a C—N bond, and R′, R″, R′″, and R″″ are hydrogen or additional organic substituents and may be the same or different. Amidines have the general structure R—C(═NR″)—N(R′″)(R″″), wherein R is an organic substituent connected to the amidine through a C—N bond, and R″, R′″, and R″″ are hydrogen or additional organic substituents and may be the same or different. Guanidines and amidines are generally more Brønsted basic and less Lewis basic than simple amines although these properties are a function of R, R′, R″, R′″, and R″″. In a CO₂ sorption system with a mixture of simple amines and guanidines (or amidines), it is presumed that the most prevalent carbamate reaction products will therefore be guanidinium (or amidinium) carbamates, where the more Lewis basic (nucleophilic) amine will comprise the anionic carbamate component of the product, and the more highly Brønsted basic, less nucleophilic guanidine (or amidine) will form the protonated component as shown in FIG. 10. In the presence of water, direct formation of guanidinium (or amidinium) bicarbonates is possible through direct reaction of the neutral guanidine or amidine with CO₂ and water (FIG. 11). Diguanidinium (or diamidinium) carbonates may also be present depending on factors such as mixture pH.

For PIMs, strong driving force for CO₂ chemisorption is created when functionalities with different reaction preferences are co-located along a polymer chain, such as a “mixed base” PIM bearing both simple amine and guanidine functionalities as shown in FIG. 10. Each functional group component (amine or guanidine) can be separately optimized for its preferred role in the CO₂ reaction process, allowing for tailoring of reaction and process energetics and providing greater driving force for chemisorption as compared to sorbent with only simple amines. When water is present, additional products arising from hydrolysis of the “mixed base” products (ammonium bicarbonates and guanidinium or amidinium bicarbonates) may form, depending on reaction features such as water concentration, relative humidity, contact time, temperature, relative CO₂ pressure, etc. In summary, several different regimes exist for sorption of CO₂ with hybrid amine/guanidine-functionalized polymeric sorbents.

In various aspects, such a guanidine-functionalized polymer and/or amidine-functionalized polymer can be used in a sorption/desorption process for removal of CO₂ from a gas phase environment, such as a cyclic sorption/desorption process. In such aspects, after sorption of CO₂ to form a sorption-enriched polymer comprising sorbed CO₂, the CO₂ sorbed to the sorption-enriched polymer can be at least partially removed to form a sorption-depleted polymer. In a cyclic process, such a sorption-depleted polymer can be ready for a subsequent cycle of sorption and desorption. Desorption can be achieved in any convenient manner. This can include modification of temperature (such as a temperature swing sorption/desorption cycle), modification of total pressure (such as a pressure swing sorption/desorption cycle), or a modification of CO₂ partial pressure. It is noted that one option for modifying a CO₂ partial pressure can be to modify the total pressure within an environment.

CO₂-containing streams can be derived from a variety of sources. Some types of CO₂ capture applications correspond to direct air capture (DAC), where air is the source of CO₂. Direct air capture applications typically operate with an input CO₂ concentration of roughly 0.04 vol %, although higher concentrations could be present if some type of preliminary CO₂ enrichment is performed. Other sources of CO₂ are exhaust or flue gases from various types of commercial power plants and/or production plants. Examples include exhaust gases from gas turbines (roughly 2.0 vol % to 4.0 vol % CO₂), exhaust gases from coal-fired power plants (roughly 8.0 vol % to 15 vol % CO₂), and exhaust gases from production of cement or steel, which can have CO₂ concentrations of up to 20 vol %, or possibly still higher. Still other sources of CO₂ can correspond to biogas streams formed during upgrading to bio-derived materials. Depending on the underlying process for forming the biogas, the CO₂ content of biogas can range from 10 vol % to 50 vol %.

### Definitions

In this discussion, the backbone structure of a polymeric repeat unit is defined to include any atoms that can form part of a continuous path for connecting atoms at opposite ends of the repeat unit. When forming such a continuous path, each atom can be used only once in forming a given continuous path. However, it may be possible to draw multiple continuous paths that include a given atom. Thus, as an example, for a repeat unit that includes a cyclic (ring) structure with a methyl side chain, the methyl side chain cannot be part of a continuous path, as any effort to include the methyl side chain as part of the path would require passing twice through the atom in the ring structure where the methyl side chain is bonded.

In this discussion, at least a portion of a ring structure is defined as being part of the backbone structure when a continuous path for connecting the atoms at the ends of a polymeric repeat unit can be formed that passes through one or more atoms participating in a ring structure. In some aspects, a backbone structure can include a plurality of atoms from a single ring structure. In some aspects, a plurality of continuous paths may be available for connecting the atoms at the ends of a repeat unit. For example, for a cyclic structure that is integral to the backbone structure, it may be possible to form separate continuous paths that differ by at least one atom from the ring structure. In such aspects, the presence of separate continuous paths can allow all atoms in a single ring structure to be part of the backbone structure, even though no single continuous path includes all of the atoms from the ring structure. As an example, in the PIM-1 repeat unit, multiple continuous paths are available for connecting atoms at the ends of the repeat unit. Based on these multiple continuous paths, all atoms within each ring structure in the PIM-1 repeat unit are part of the backbone structure under the definition provided herein.

Based on the above definitions, it is noted that for a PIM-1 repeat unit, the atoms in the repeat unit that are not part of the backbone structure correspond to a) the two nitrile groups, and b) the methyl groups on the cyclopentyl ring. Similarly, for Py-PIM, the atoms in the repeat unit that are not part of the backbone structure are a) the single nitrile unit attached to the pyridine ring, and b) the methyl groups on the cyclopentyl ring.

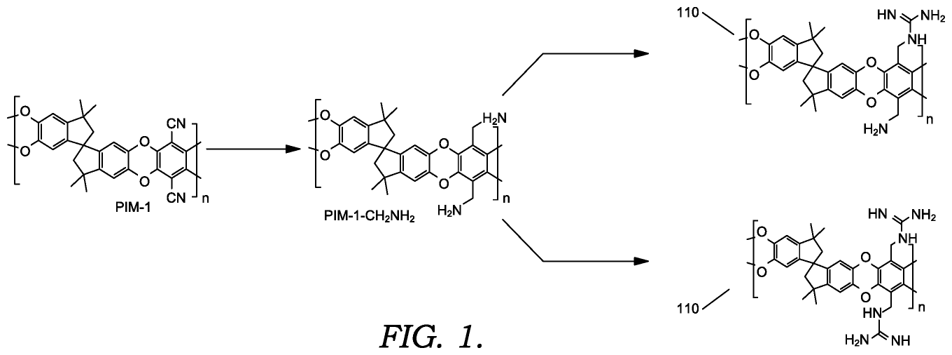

In this discussion, guanidine derivative substituent is defined as any side chain attached to a PIM backbone structure that includes a) a central carbon atom that is bonded to b) three separate nitrogen atoms, with at least one of the bonds to a nitrogen atom having iminic (imine or double bond) and/or aromatic character. In some aspects, a guanidine derivative can correspond to a guanidinyl functional group, so that the only modification of the functional group relative to a guanidine molecule is the modification needed to bond the guanidinyl functional group to the PIM backbone structure and/or to a side chain attached to the PIM backbone structure. Optionally, the guanidine derivative in the side chain can be separated from the backbone structure by at least one aliphatic carbon, at least one aromatic carbon, or a combination thereof. As an example, the guanidinyl-substituted PIM-1 shown in FIG. 1 (discussed below) has a side chain that includes an initial methylene group that is bonded to one of the atoms in the backbone structure. A nitrogen in the guanidinyl functional group is then bonded to this methylene group. The carbon in the methylene group corresponds to an aliphatic carbon. Thus, the guanidinyl functional group shown in FIG. 1 is separated from the backbone structure by one aliphatic carbon.

In this discussion, a guanidine-substituted PIM is defined as a PIM where at least a portion of the repeat units are modified to include a guanidine derivative substituent. Optionally, the guanidine derivative substituent can correspond to a guanidinyl group.

In this discussion, amidine derivative substituent is defined as any side chain attached to a PIM backbone structure that includes a) a central carbon atom that is bonded to b) two separate nitrogen atoms and one carbon atom, with at least one of the bonds to a nitrogen atom having iminic (imine or double bond) and/or aromatic character. In some aspects, an amidine derivative can correspond to a amidinyl functional group, so that the only modification of the functional group relative to an amidine molecule is the modification needed to bond the amidinyl functional group to the PIM backbone structure and/or to a side chain attached to the PIM backbone structure. Optionally, the amidine derivative in the side chain can be separated from the backbone structure by at least one aliphatic carbon, at least one aromatic carbon, or a combination thereof.

In this discussion, an amidine-substituted PIM is defined as a PIM where at least a portion of the repeat units are modified to include a amidine derivative substituent. Optionally, the amidine derivative substituent can correspond to a amidinyl group.

In this discussion, a functionalization location refers to a location in a PIM repeat unit where the repeat unit can be functionalized to include a guanidine derivative and/or amidine derivative. For example, for PIMs that include one or more nitrile groups in a repeat unit, the functionalization locations can correspond to the number of locations in a PIM repeat unit that correspond to nitrile groups. Thus, PIM-1 includes two functionalization locations per repeat unit, while Py-PIM includes only one nitrile per repeat unit. The amount of functionalization of a PIM with a guanidine derivative can be characterized based on the percentage of functionalization locations that are functionalized with a guanidine derivative versus the total number of functionalization locations. This percentage corresponds to a number average across a given PIM sample. It is noted that such functionalization with guanidine derivatives and/or amidine derivatives may not be evenly distributed throughout a polymer structure. Thus, a PIM 1 structure with 50% functionalization with guanidine derivatives may include some repeat units that include two guanidine derivatives while having other repeat units that include no guanidine derivatives. A PIM structure where less than 100% of the functionalization locations are functionalized with a guanidine derivative can be referred to as a partially functionalized PIM. In some aspects, a PIM can have 20% or more of functionalization locations that correspond to a guanidine derivative, or 40% or more, or 50% or more, or 60% or more, or 75% or more, such as up to substantially all of the functionalization locations corresponding to a guanidine derivative. In some aspects, a PIM can have 20% to 75% of the functionalization locations corresponding to guanidine derivatives, or 20% to 60%, or 20% to 50%, or 20% to 40%, or 40% to 75%, or 40% to 60%, or 50% to 75%, or 60% to 75%. It is also possible to attach multi-guanidine bearing derivatives at a functionalization location. For example, in some aspects, a PIM can be functionalized so that 70% or more of the repeat units (such as up to 100%) have a substituent corresponding to a guanidine derivative, or 30% to 70%, or 40% to 60%, or 10% to 30%.

Forming Polymers of Intrinsic Microporosity Functionalized with Guanidine Derivatives

The examples below describe various methods for addition of guanidine derivative functional groups as substituents to the polymer backbone for polymers of intrinsic microporosity. FIG. 1 shows an example of a reaction scheme for addition of guanidine derivative functional groups as substituents to the polymer backbone for PIM-1, a polymer of intrinsic microporosity. As show in FIG. 1, PIM-1 can be reacted with borane dimethylsulfide in a tetrahydrofuran solution environment to convert the nitrile substituents in the PIM-1 into aminomethyl substituents (i.e., side chains corresponding to a methylene group and a primary amine attached to the methylene). This conversion can be accomplished, for example, by reacting the PIM-1 with the borane dimethylsulfide overnight under reflux conditions at a temperature of roughly 50° C.

After converting the nitrile substituents to aminomethyl substituents, the resulting functionalized PIM can be separated from the solvent environment. The PIM can then be exposed to conditions for conversion of at least a portion of the aminomethyl substituents to guanidines and/or guanidine derivatives. For example, the PIM can then be reacted with 1H-pyrazole-1-carboxamidine hydrochloride and diisopropylethylamine in dimethylformamide at 70° C. for a period of a few days, then rinsed with methanol and treated with sodium methoxide in methanol at room temperature, to convert at least a portion of the aminomethyl substituents into guanidines. Alternatively, the PIM can then be reacted with cyanamide in a water/ethanol solvent environment at a temperature between 50° C. to 100° C. for a time period between 1 hour and 100 hours to convert at least a portion of the aminomethyl substituents into guanidines.

The amount of amines that are converted to guanidine derivatives is dependent on the reaction specifics. When less guanidinylating reagent is added, at least a portion of the repeat units after the reaction can correspond to repeat unit 110 in FIG. 1. Repeat unit 110 corresponds to a functionalized PIM-1 where a portion of the potential locations for functionalization correspond to guanidine derivatives. In repeat unit 110, one substituent corresponds to a guanidinyl functional group (attached via an intervening methylene group), while a second substituent corresponds to an aminomethyl substituent on the PIM backbone. At conditions favoring greater guanidinylation, such as when more guanidinylating reagent is added, an increasing portion of the repeat units can correspond to repeat unit 120. Repeat unit 120 corresponds to a functionalized PIM-1 repeat unit where both locations for functionalization correspond to guanidine derivatives. It is understood that by selecting appropriate reaction conditions, any convenient combination of the repeat unit 110, repeat unit 120, and repeat units without any functionalization by guanidine derivatives can be included in a PIM.

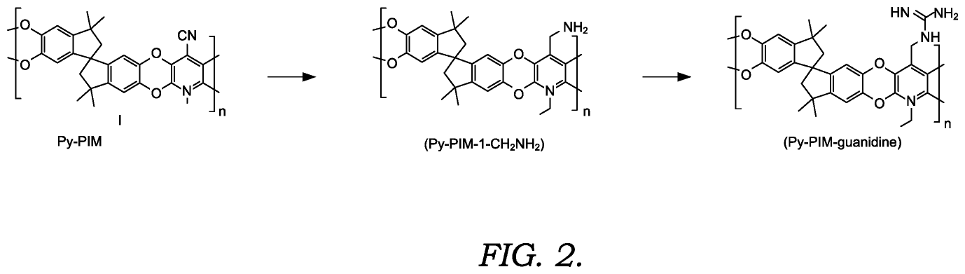

Other types of PIMs can be used to form functionalized PIMs. FIG. 2 shows an example of a repeat unit structure for a PIM that is similar to PIM-1, but includes a pyridine ring at the ring where the nitrile groups in PIM-1 are attached (Py-PIM). Because of the presence of the nitrogen atom in the pyridine ring, Py-PIM includes only one nitrile substituent, instead of the two in PIM-1. As shown in the reaction scheme in FIG. 2, the nitrile group in Py-PIM can be converted to guanidine derivative via an aminomethyl intermediate in a manner similar to functionalization for PIM-1.

More generally, it is noted that many types of PIMs are made by polymerization using a plurality of types of monomer units to form a PIM repeat unit. One type of reaction scheme to form PIMs is to use a first type of monomer containing catechol groups and a second type of monomer containing halogens to allow for formation of a repeat unit that includes a backbone structure corresponding to a PIM. PIMs where the repeat unit is based on a monomer that includes a nitrile group are examples of PIMs that can be functionalized to include a guanidine derivative. Examples of monomer units that contain a nitrile group that can be used to form a PIM repeat unit include 1,4-cyano-2,3,5,6-fluorobenzene and 4-cyano-2,3,5,6-fluorobenzene. It is noted that other halogens could be used in place of fluorine in the nitrile-containing monomer unit. Examples of PIMs where the repeat unit can be formed using a nitrile-containing monomer unit include, but are not limited to, PIM-1, PIM-4, PIM-CO-100, PIM-CO-15, and PIM-HP3.

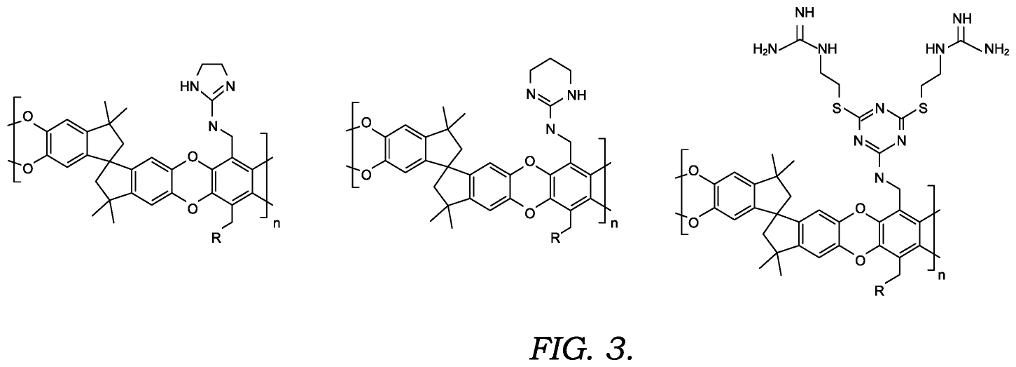

Additionally or alternately, various types of additional functionalization strategies can be used to make functionalized PIMs with different types of functional groups and/or mixtures of functional groups. FIG. 3 shows examples of additional guanidine derivative functional groups that can be used in functionalized PIMs. In FIG. 3, the “R” group in the repeat unit can be any convenient functional group, such as the same group present in the para-position on the ring, or aminomethyl, or another substituent. In FIG. 3, the additional structures shown correspond to substituents with Brønsted base properties that are at least partly analogous the Brønsted base properties of a guanidinyl functional group.

### Example 1—Synthesis of Fully Guanidinylated PIM-1

PIM-1 was synthesized following the literature procedure with slight modifications (Macromolecules 2014, 47, 1021-1029.). All reagents not specified otherwise were reagent grade or better and used without further purification. Dimethylformamide (DMF) used in guanidinylation reactions was anhydrous grade. Tetrahydrofuran (THF) was dried/de-oxygenated. Other solvents used in chemical reactions were HPLC grade (dried over 3 Å molecular sieves). Solvents used for material washings were of ACS grade.

A 2.0 g (4.35 mmol repeat units) portion of the synthesized PIM-1 was dissolved in 70 mL dry THF in a round-bottomed flask under inert (N₂) atmosphere. The solution was cooled down to 0° C. and neat BH₃·SMe₂ (20.0 mL, 212.48 mmol) was added dropwise while the reaction mixture was stirred vigorously. A yellow precipitate started forming during addition of BH₃·SMe₂. After stirring for 5 min in an ice bath, the reaction mixture was allowed to attain room temperature, and subsequently heated to reflux (80-85° C.) overnight. The reaction was quenched by dropwise addition of methanol (MeOH) at 0° C. The yellow precipitate was collected by filtration, and thoroughly washed with THF (×2 washes), followed by MeOH (×6 washes). The solid was suspended in 10% aqueous HCl and stirred for 4 h. During this period the color of the solid changed to pale orange. The solid was collected by filtration, washed thoroughly with doubly distilled water, followed by MeOH, and subsequently was stirred in 5% aqueous NaOH for ˜40 h at room temperature to neutralize the acid. The solid was collected by filtration, washed thoroughly with water until the pH of the filtrate became neutral, was further washed with MeOH, and finally dried under dynamic vacuum at 85° C. to obtain PIM-1-CH₂NH₂ (“PIM-1-amine”, 1.78 g).

Subsequently, a 1.0 g/2.14 mmol portion of PIM-1-amine (2.14 mmoles repeat units) was added to a round bottomed flask under N₂ atmosphere along with 1H-pyrazole-1-carboxamidine hydrochloride (“PC·HCl”, 1.63 g, 11.1 mmol) and 35 mL of anhydrous DMF. The mixture was stirred for 5-7 min at room temperature to let 1H-pyrazole-1-carboxamidine hydrochloride completely dissolve in DMF. Dry diisopropylethylamine (DIPEA) (1.94 mL, 11.1 mmol) was then added to this suspension while stirring. The reaction vessel was then transferred to an oil bath heated at 70° C. and stirred under N₂ atmosphere for 3 days. After 3 days the reaction mixture was allowed to attain room temperature followed by separating the solid crude out of the reaction solution by filtration. The solid was thoroughly washed with MeOH and air-dried. To another round bottomed flask charged with 1.2 g (22.2 mmol) NaOMe, 40 ml HPLC grade MeOH was added and subsequently stirred vigorously for 10 min. To this slightly turbid solution the air-dried guanidinylated polymer solid was added and stirred for 3-4 hours to neutralize the HCl complexed with the guanidine units. At this point, the product was isolated through filtration and thorough washing with MeOH. The product was finally dried in a vacuum oven under dynamic vacuum at 115° C. to obtain guanidinylated PIM-1 (1.09 g). This structure is referred to herein as PIM-1-guan or PIM-1-guan 100.

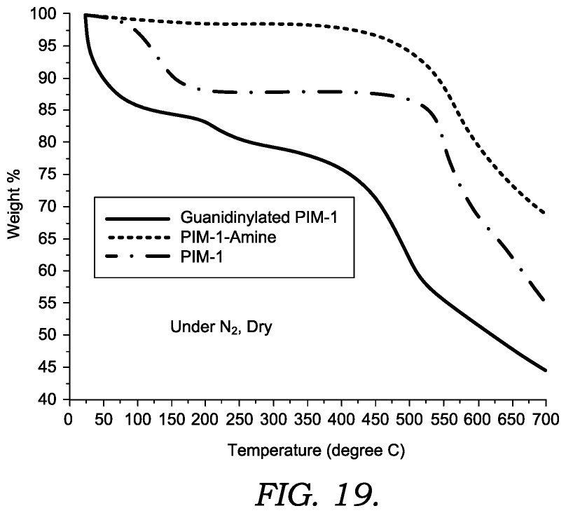

It is noted that thermogravimetric analysis was used to investigate the stability of the PIM-1, PIM-1-amine, and PIM-1-guan. FIG. 19 shows results from the thermogravimetric analysis.

### Example 2—Synthesis of Partially Guanidinylated PIM-1

PIM-1 bearing both amine and guanidine groups was synthesized by adding a limited amount of the guanidinylating reagent (1H-pyrazole-1-carboxamidine hydrochloride, “PC·HCl”) with respect to the starting material (PIM-1-amine) to allow good control of the average ratio of primary amine to guanidine units. Three different round bottomed flasks were prepared, each containing 800 mg (1.71 mmol repeat units) of PIM-1-amine. To each of these was added between 0.9-3.0 mmol of PC·HCl followed by addition of a near equivalent molar amount of DIPEA. Subsequently, 30 ml anhydrous DMF was added to each of the flasks under N₂ atmosphere. The reaction flasks were then transferred to an oil bath heated at 70° C. and stirring was continued for 3 days. After 3 days the reaction mixture was allowed to attain room temperature followed by separating the solid crude out of the reaction solution by filtration. The solids were thoroughly washed with MeOH and air-dried. Three fresh round bottomed flasks were each charged with 4 eq. of NaOMe per equivalent of PC·HCl along with 40 mL HPLC grade methanol. The contents of each flask were subsequently stirred vigorously for 10 min giving slightly turbid solutions. To these flasks the sample of the respective air-dried solid to be free based was added and the mixture was then stirred for 3-4 hours to neutralize the HCl complexed with the guanidine units. At this point, the polymeric products were isolated through filtration and thorough washing with MeOH. The products were finally dried in a vacuum oven under dynamic vacuum at 115° C. to obtain partially guanidinylated PIM-1-amines. These samples are shown in Table 1 below.

To summarize the three syntheses of partially guanidinylated PIM-1:
2A: 800 mg (1.71 mmol) PIM-1-amine was reacted with 125 mg (0.86 mmol) PC·HCl and 0.15 mL (0.111 g, 0.86 mmol) DIPEA. The product was reacted with 184.7 mg (3.42 mmol) NaOMe (˜4 eq. NaOMe per mole PC·HCl). This structure is referred to herein as PIM-1-guan23.
2B: 800 mg (1.71 mmol) PIM-1-amine was reacted with 251 mg (1.47 mmol) PC·HCl and 0.30 mL (0.223 g, 1.72 mmol) DIPEA. The product was reacted with 315.9 mg (5.85 mmol) NaOMe (˜4 eq. NaOMe per mole PC·HCl). This structure is referred to herein as PIM-1-guan40.
2C: 800 mg (1.71 mmol) PIM-1-amine was reacted with 460.4 mg (3.07 mmol) PC·HCl and 0.61 mL (0.453 g, 3.50 mmol) DIPEA. The product was reacted with 665 mg (12.31 mmol) NaOMe (˜4 eq. NaOMe per mole PC·HCl). This structure is referred to herein as PIM-1-guan49. These samples are also shown in Table 1 below.

### Example 3. Characterization and Quantification of PIM-1-guan-100 and Partially Guanidinylated Compositions in Examples 1 and 2

Solid-state quantitative ¹³C NMR (nuclear magnetic resonance) spectroscopy was performed to quantify the conversion and bulk purity of the product PIM-1-guanidines. The ¹³C NMR was conducted using a Bruker AV3-HD 300 MHz spectrometer (providing 75 MHz for ¹³C NMR). Qualitative measurements were taken using a ¹³C CP Magic Angle Spinning (MAS) sequence at 14 KHZ with a 4 mm MAS rotor (contact time 3 mS, ramp-shaped contact pulse for 1H, 4096 scans, 4 S recycle delay, 1024 complex data points recorded, spectral width 300 ppm). Quantitative measurements were taken on the same apparatus using a composite pulse MultiCP MAS sequence (contact time 100 mS, 512 scans, 5 S recycle delay, same number of data points and spectral width, and a proton repolarization time (d11) of 2×T1 (T1 was measured in a separate experiment using a saturation recovery sequence). Data was plotted using Bruker TopSpin 3.6.2 software.

Attenuated total reflectance (ATR) infrared (IR) spectra were also obtained to show absence of any residual starting material in the fully aminated and guanidinylated products. ATR-IR solid state spectroscopy was conducted using a Perkin-Elmer Spectrum Two FTIR spectrometer in ATR mode (diamond plate) at a resolution of 4 cm⁻¹. A total of 32 scans were collected and data was analyzed using Spectrum Two SP-10 software, Automatic Performance Variation (APV). Spectra were plotted with Origin2021.

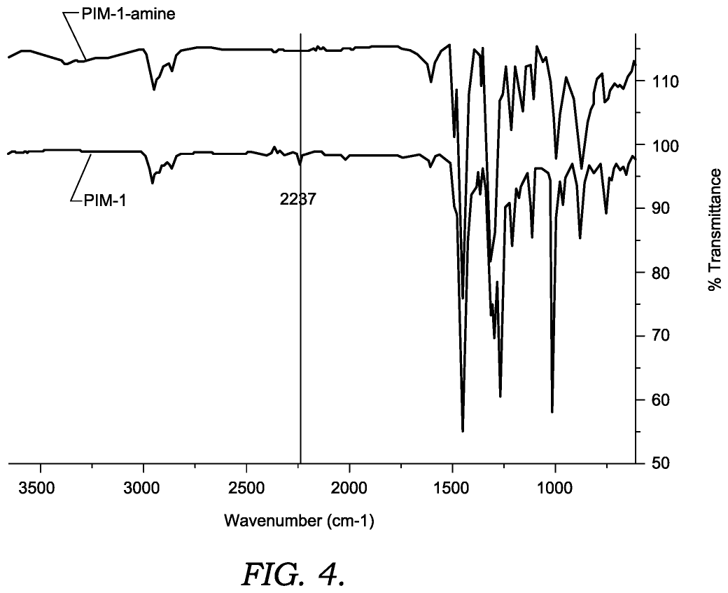

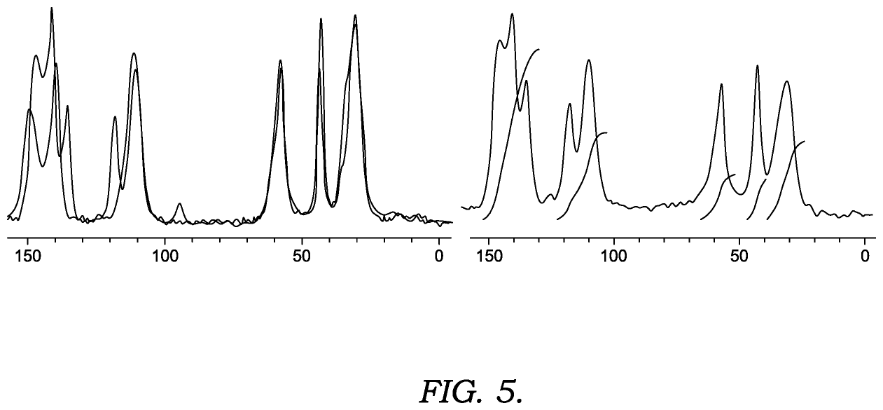

The complete conversion of PIM-1 to PIM-1-amine was confirmed from the disappearance of the C≡N stretching frequency at 2237 cm⁻¹ in the ATR infrared spectrum of PIM-1-amine as shown in FIG. 4. In FIG. 4, the lower spectrum corresponds to PIM-1 while the upper spectrum corresponds to PIM-1-amine. As shown in FIG. 4, the peak in the lower spectrum at 2237 cm⁻¹ is no longer present in the upper spectrum. The peak at 2237 cm⁻¹ in the lower spectrum corresponds to a nitrile stretch. The absence of this peak in the upper spectrum shows that the nitrile groups have been substantially completely removed in the PIM-1-amine. This replacement of the nitrile group with an aminomethyl can also be observed via ¹³C-NMR. FIG. 5 shows a ¹³C-NMR overlay of PIM-1 and PIM-1-amine spectra at left, and a ¹³C-NMR spectrum of PIM-1-amine at right. The nitrile carbon undergoes significant upfield shift (48=80 ppm) from ˜110-115 to ˜35 ppm upon reduction to the corresponding —CH₂NH₂ amine group (appearing as a broadened peak along with the —CH₃ resonances), and the directly attached aromatic ring carbon at ˜90 ppm moves upfield to a new resonance at ˜120 ppm. One neighboring aromatic carbon, adjacent to the aromatic carbon bearing the nitrile/amine substituent, also shifts upon the reduction of nitrile to amine, from the peak cluster at ˜140 ppm to a new peak at ˜135 ppm.

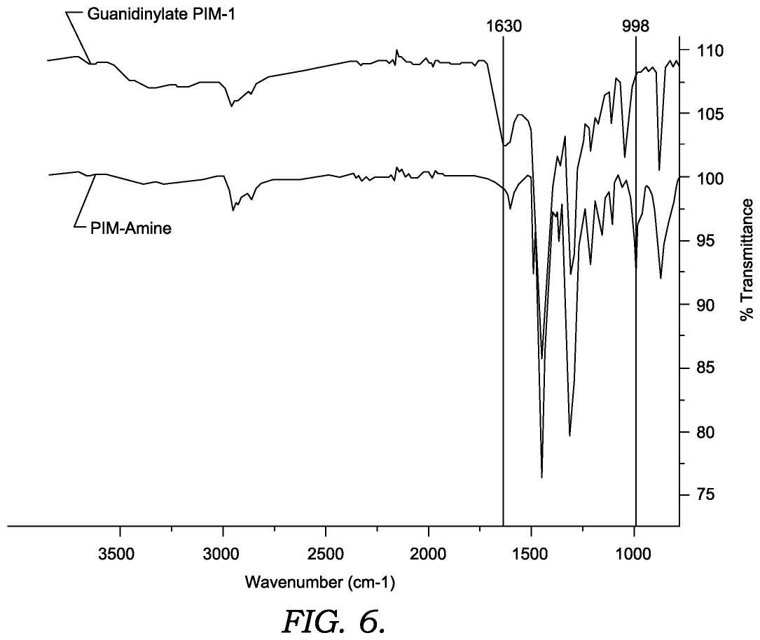

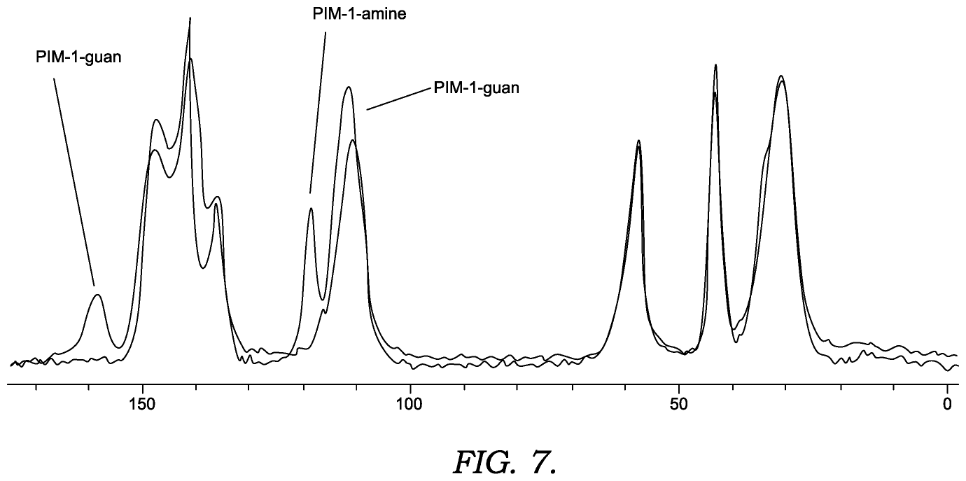

Complete conversion of PIM-1-amine to its guanidinylated derivative is shown in overlaid ATR infrared spectra (FIG. 6) and solid-state ¹³C-NMR (quantitative) (FIG. 7). In FIG. 6, the newly present signal in the ATR spectra at 1630 cm⁻¹ represents the newly formed guanidine carbons (C═NH). The stretch at 998 cm⁻¹ corresponds to a C—N stretch in a primary amine, which shifts and/or disappears after guanidinylation. Similarly, in FIG. 7 the newly present signal in the NMR spectra at ˜157 ppm represents the newly formed guanidine carbons (C═NH). In addition to these signature changes, in FIG. 7, the characteristic NMR signal corresponding to the aromatic carbons bearing the primary benzyl amines in PIM-1-amine from 119 ppm disappears (showing the absence of residual amines) and relocates underneath the broad signal at 106-116 ppm.

For the partially guanidinylated samples of Example 2, similar ¹³C-NMR spectra were obtained. The ¹³C-NMR spectra for the partially guanidinylated samples were then used to determine the relative amounts of primary amines and guanidinyl groups in the sample. The molar content of primary amines and guanidine units was calculated by comparing the signal integration value of the broad ¹³C SS NMR shoulder at 119 ppm (PIM-1-amine, adjacent to the signal at 113 ppm) with the newly appeared guanidine signal at ˜157 ppm as shown in FIG. 7. An optimized deconvolution method with Gaussian/Lorentzian curve fitting (with 1000 iteration) was used on the NMR spectra. Based on this method, it was determined that PIM-1-guan23 was functionalized with a guanidine derivative at 23% of the possible locations relative to the fully functionalized sample. Similarly, PIM-1-guan40 was functionalized with a guanidine derivative at 40% of the possible locations, while PIM-1-guan49 was functionalized with a guanidine derivative at 49% of the possible locations.

### Example 4. Synthesis of Fully Guanidinylated PIM-1 Fibers

First, PIM-1-amine fibers were formed from PIM-1 fibers. To 200 mg (0.44 mmol repeat units) of PIM-1 fibers in a sealed round-bottomed flask was added 20 mL dry diethyl ether under inert (N₂) atmosphere. Prior to reaction, the PIM-1 fibers had a bright yellow color (fluorescent under UV). The solution was cooled down to 0° C. and neat BH₃·SMe₂ (3.5 mL, 37.3 mmol) was added dropwise while the reaction mixture was stirred vigorously. After stirring for 15 min in an ice bath, the reaction mixture was allowed to attain room temperature while stirring, and subsequently heated to reflux (65-70° C.) for 24 h. At the end, the reaction was quenched by dropwise addition of MeOH at 0° C. The fibers turned to pale yellow at the end and were collected by filtration, and thoroughly washed with MeOH (×6). The solid was suspended in 10% HCl and stirred for 5 h, during which the color of the fibers changed to pale orange. After 5 hours the pale orange fibers were collected by filtration, washed thoroughly with doubly distilled water, followed by MeOH, and subsequently stirred in 5% aqueous NaOH for ˜40 h at room temperature to neutralize the acid. At this point the color of the fibers changed back to pale yellow; they were collected by filtration, and washed thoroughly with water until the pH of the filtrate became neutral. The fibers were further washed with MeOH, and finally dried under dynamic vacuum at 85° C. to obtain pale yellow amine-functionalized PIM fibers (199 mg) which are no longer fluorescent.

Next, the PIM-1-amine fibers were converted to fibers that included a guanidine derivative. To a round bottomed flask containing fibers of PIM-1-amine (190 mg, 0.41 mmol repeat units) was added 320 mg (2.20 mmol) of PC·HCl. Subsequently, 12 ml of anhydrous DMF was added to the flask under N₂ atmosphere. The mixture was stirred for 10 min at room temperature to let the PC·HCl completely dissolve in DMF. Dry DIPEA (0.38 ml, 2.20 mmol) was then added to this mixture while stirring. The reaction vessel was transferred to an oil bath, heated at 70° C., and stirred under N₂ atmosphere for 3 days. After 3 days the reaction mixture was allowed to attain room temperature followed by separating the pale brown fibers out of the reaction solution by filtration. The fibers were thoroughly washed with MeOH and air-dried. Subsequently, to another round bottomed flask charged with 475.3 mg (8.8 mmol) NaOMe, 25 ml HPLC grade MeOH was added and subsequently stirred vigorously for 15 min. To this slightly turbid solution, the air-dried fibers were then added, and stirred for 4-5 hours to neutralize the HCl complexed with the guanidine units. At this point, the neutralized fibers were isolated through filtration and thorough washing with MeOH. The fibers were finally dried in a vacuum oven under dynamic vacuum at 115° C. to obtain light brown guanidinylated PIM-1 fibers (210 mg).

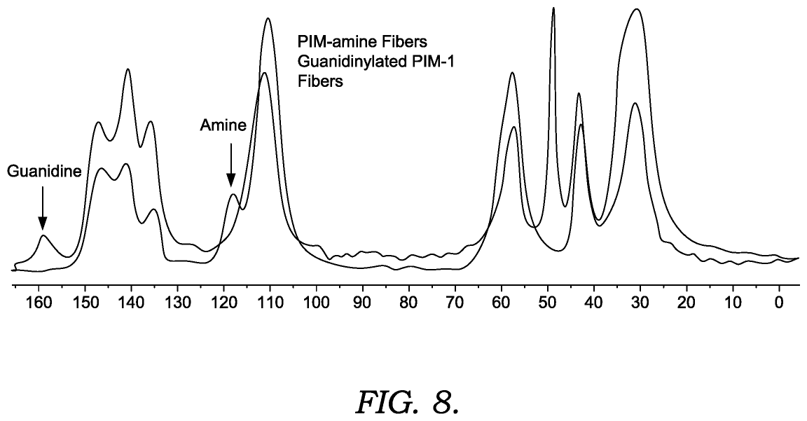

FIG. 8 shows ¹³C NMR solid state characterization of the PIM-1-amine and PIM-1-guan fibers prepared in Example 4. The benzyl amine signal of PIM-1-CH₂NH₂ at 119 ppm disappears completely and undergoes a slight upfield shift, joining the existing peak centered at 110 ppm, when the amines fully guanidinylate. A broad guanidine C═N signal also appears at ˜158 ppm.

Table 1 summarizes all of the guanidinylated PIM-1 samples and precursors.

TABLE 1
Summary of Samples Related to Guanidinylation of PIM-1

| | | | Averaged repeat | |
|---|---|---|---|---|
| | | Averaged | unit molecular | |
| | | repeat unit | weight per | Millimoles of |
| | Molar ratio of | molecular | chemisorptive | chemisorption |
| | guanidine:amine | weight | amine/guanidine | amine/guanidine |
| Material | sites | (g/mol) | site (g/mol) | site per gram |
| PIM-1 | — | 460.49 | 230.25 (nitrile | 4.34 (nitrile |
| (comparative Ex.) | | | groups) | groups) |
| PIM-1-amine | 0:100 | 468.56 | 234.28 | 4.27 |
| (comparative Ex.) | | | | |
| PIM-1-amine | 0:100 | 468.56 | 234.28 | 4.27 |
| fibers (Ex. 3) | | | | |
| PIM-1-guan23 | 23:77 | 487.90 | 243.95 | 4.10 |
| (Ex. 2A) | | | | |
| PIM-1-guan40 | 40:60 | 502.19 | 251.10 | 3.98 |
| (Ex. 2B) | | | | |
| PIM-1-guan49 | 49:51 | 511.44 | 255.72 | 3.91 |
| (Ex. 2C) | | | | |
| PIM-1-guan100 | 100:0 | 552.64 | 276.32 | 3.62 |
| (Ex. 1) | | | | |
| PIM-1-guan | 100:0 | 552.64 | 276.32 | 3.62 |
| fibers (Ex. 4) | | | | |

CO₂ sorption isotherms were taken on a Micromeritics ASAP 2020 instrument running MicroActive software. The degas (evacuation) cycle was conducted at 150° C. for 720 minutes (hold pressure 100 mm Hg) with a ramp rate to this temperature of 10° C./minute. Isothermal analysis was conducted at 30° C. for 720 minutes under CO₂ at gradually increasing pressures up to 1 bar. Data was plotted with Origin2021.

CO₂ sorption isobars were taken using a TA Instruments Q500 QSeries Thermogravimetric Analyzer (TGA). Data was analyzed using TA Universal Analysis software. Starting at room temperature, the sample was heated to 150° C. at a ramp rate of 20° C./minute under an air flow of 90 mL/minute. It was held at 150° C. for 80 minutes as a pre-drying step under a nitrogen flow of 90 mL/minute. The adsorption portion of the isobar was taken by cooling to 30° C. at a rate of 0.5° C./minute under a CO₂ flow of 25 mL/minute. The desorption portion was taken by heating to 150° C. under identical conditions.

Sorption kinetics experiments were performed using an identical instrument. The sample was first heated at 150° C. under nitrogen for 80 minutes, then cooled to 30° C. under dry nitrogen flowing at a rate of 90 mL/minute. CO₂ sorption was conducted at 30° C. for 6 hours under a dry CO₂ flow of 25 mL/minute, followed by desorption (under the same gas flow) by heating to 150° C. at a rate of 0.5° C./minute.

Humid sorption kinetics experiments were performed using a TA TGA500 instrument. The sample was first heated at 150° C. under nitrogen for 60 minutes, then cooled to 30° C. under dry nitrogen flowing at a rate of 90 mL/minute. The sample was then saturated with moisture through the flow of humid N₂ (at 50% RH, 30° C.) for 2 hours. CO₂ sorption was then conducted at 30° C. for 2 hours under a moist CO₂ flow of 25 mL/minute, followed by desorption (under dry N₂) by heating to 150° C. at a rate of 0.2° C./minute. The humid adsorption steps were performed by flowing the gases through a LI-COR humidifier (portable dew point generator, Model LI-610) and then through the sample.

Sample decomposition profiles were taken using an identical instrument. Starting at room temperature, the sample was heated at a rate of 15° C./minute to 800° C. in air with a 90 mL/minute flow. It was then held at 800° C. for 30 minutes under the same air flow, and cooled to 30° C. at a rate of 20° C./minute under the same air flow.

### Example 5—Isothermal Dry CO₂ Sorption Data of Guandinylated PIM-1-Derivatives

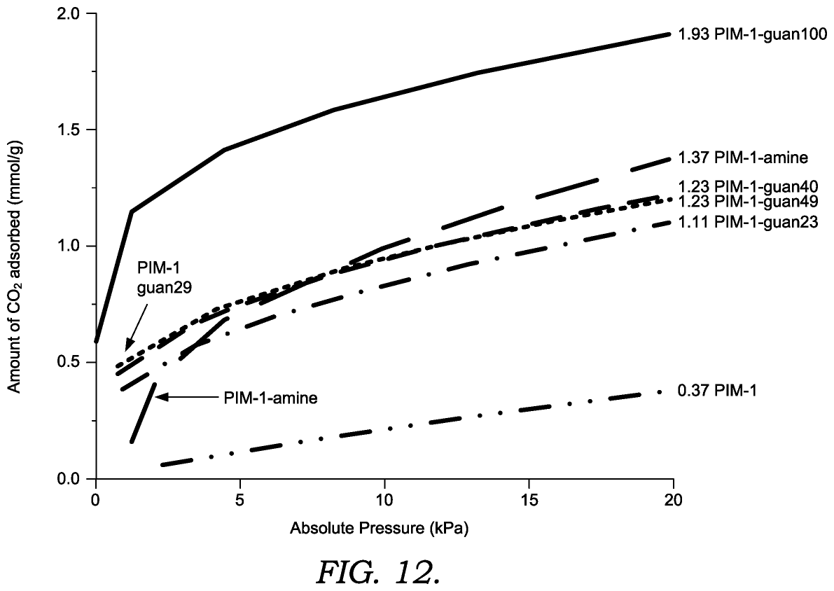

FIG. 12 shows dry pure CO₂ isothermal sorption data of the fully and partially guanidinylated non-fiber PIM-1 samples in Table 1 along with comparatives (PIM-1, PIM-1-amine). CO₂ uptake values at pressure points approximating 4% and 12% CO₂ in the feed gas are summarized in Table 2. The sorption data is tabulated on both on a per gram of sorbent basis and on a per millimole of amine/guanidinyl basis (molar efficiency). Molar efficiency is calculated by dividing mmol CO₂ uptake by mmol functional group per gram (Table 1, where functional group=amine or guanidinyl). It is noted that based on this definition of molar efficiency, the molar efficiency is not rigorously comparable for the PIM-1 sample, as the PIM-1 sample does not include either a strongly chemisorbing guanidinyl or amine group. As an approximation, the molar loading of nitrile groups per gram are used to calculate this value for PIM-1. The fully guanidinylated and two higher guanidine content partially guanidinylated materials (PIM-1-guan 100, PIM-1-guan40, and PIM-1-guan49) show higher CO₂ uptake than PIM-1-amine and PIM-1 at low CO₂ feed concentration (up to about 8% CO₂) on both a per gram and molar efficiency basis (note that the Table 2 uptake for PIM-1-guan40 is 0.01 mmol/g lower than that of PIM-1-amine, but taken at a data point with a 1.03% lower CO₂ concentration). These materials furthermore show higher CO₂ uptake than PIM-1-amine and PIM-1 on a molar efficiency basis at somewhat higher CO₂ pressures, such as at 12% CO₂ or higher in the feed. This demonstrates the improved, stronger affinity of the more basic, guanidine-bearing materials for CO₂ under the most difficult sorption conditions (those with the lowest CO₂ concentrations). The class of gas feeds containing 12% or less CO₂ includes industrially important feeds such as power plant exhausts (flue gases) and ambient air.

TABLE 2
Dry Isothermal CO₂ Uptake for PIM-1-Derivatives at 30°
C. As Shown in FIG. 12. Parenthetical values underneath main
values indicate the exact pressure in kPa for data collection.

| | | ~4% | | ~12% |
|---|---|---|---|---|
| | ~4% | Uptake, | ~12% | Uptake, |
| | Uptake, | molar | Uptake, | molar |
| Material | mmol/g | efficy. | mmol/g | efficy. |
| PIM-1 | 0.09 | 0.021 | 0.26 | 0.060 |
| | (3.67) | | (12.49) | |
| PIM-1- | 0.67 | 0.157 | 1.07 | 0.251 |
| amine | (4.40) | | (11.92) | |
| PIM-1- | 0.57 | 0.139 | 0.89 | 0.217 |
| guan23 | (3.37) | | (11.80) | |
| PIM-1- | 0.66 | 0.166 | 1.05 | 0.264 |
| guan40 | (3.37) | | (13.49) | |
| PIM-1- | 0.73 | 0.187 | 1.02 | 0.261 |
| guan49 | (4.21) | | (12.66) | |
| PIM-1- | 1.41 | 0.390 | 1.72 | 0.475 |
| guan100 | (4.42) | | (12.31) | |

*Defining the nitrile group of PIM-1 as the functional group.

### Example 6—Isobaric Dry CO₂ Sorption Data of Sample PIM-1-guan100

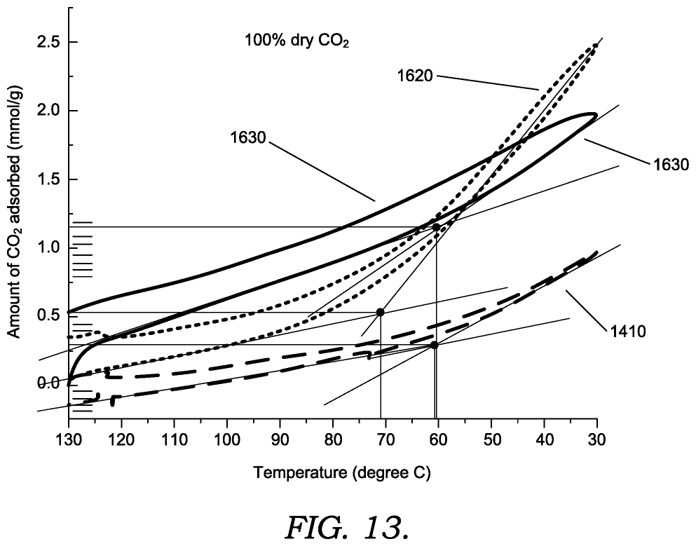

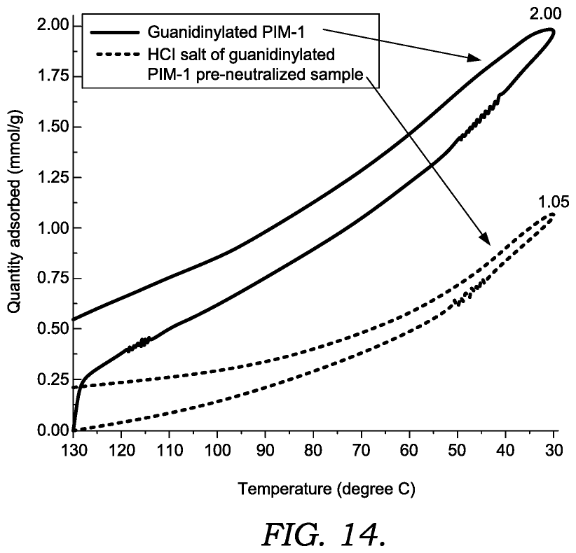

FIG. 13 shows dry 1 atm CO₂ isobaric sorption data of fully guanidinylated sample PIM-1-guan 100 (curve 1630) and comparative samples PIM-1-amine (curve 1620) and PIM-1 (curve 1410). In FIG. 14, the lower line of each curve corresponds to the cooling portion of the curve. The cooling portion of the data (lower line) is summarized in Table 3 both on a per gram of sorbent basis (col. 2, 4, 6) and on a per millimole of amine/guanidine basis (molar efficiency, col. 3, 5, 7). The PIM-1-guan100 has greater overall sorption efficiency per gram than PIM-1-amine at all temperatures above 54° C., and greater molar efficiency than PIM-1-amine at all temperatures above about 37° C. It is noted that at 110° C., the PIM-1 effectively had no sorption capacity for CO₂.

TABLE 3
Dry Isobaric 1 atm CO₂ Uptake For PIM-1-Derivatives.

| | 30° C. | | 70° C. | | 110° C. | 110° C. |
|---|---|---|---|---|---|---|
| | Uptake, | | Uptake, | | Uptake, | Uptake, |
| | mmol | 30° C. Uptake, | mmol | 70° C. Uptake, | mmol | molar |
| Material | CO₂/g | molar efficiency | CO₂/g | molar efficiency | CO₂/g | efficiency |
| PIM-1- | 1.98 | 0.55 | 1.05 | 0.29 | 0.50 | 0.14 |
| guan100 | | | | | | |
| PIM-1- | 2.49 | 0.58 | 0.80 | 0.19 | 0.20 | 0.05 |
| amine | | | | | | |
| PIM-1 | 1.00 | N/A | 0.25 | N/A | ~0 | N/A |

| | 35° C. | | | |
|---|---|---|---|---|
| | Uptake, | | | |
| | mmol | 35° C. Uptake, | 40° C. Uptake, | 40° C. Uptake, |
| Material | CO₂/g | molar efficiency | mmol CO₂/g | molar efficiency |
| PIM-1- | 1.83 | 0.51 | 1.72 | 0.48 |
| guan100 | | | | |
| PIM-1-amine | 2.20 | 0.52 | 1.98 | 0.46 |

In FIG. 13, it is clearly seen that each material shows a different profile of sorption response to temperature in two different regimes, represented by differing slopes of mmoles CO₂ sorbed per gram of sorbent (or per millimoles of functional groups) per degree Celsius of temperature. Lines drawn to define each regime and calculate the inflection temperature boundaries between the regimes are shown in FIG. 13. For each material, a sorption-temperature response profile in both the lower and higher temperature regimes can be calculated from the slope of the lines (Table 4). In the higher temperature regime, where greater sensitivity to temperature is an advantage for minimizing energy use for the desorption step of a temperature-swing process, the PIM-1-guan100 is more sensitive to temperature than the PIM-1-amine (and the PIM-1 itself) on both a gram and functional group basis. This trend suggests that the guanidine sites are weaker nucleophiles than the amine sites. In contrast, in the lower temperature regime, where the adsorption stage of a process would take place, the PIM-1-guan 100 is less sensitive than the PIM-1-amine and behaves similarly to PIM-1. This means that the sorption stage of the cycle may be run with less concern for local heat buildup and management, again consistent with the weaker nucleophilicity (lower heat of reaction) of the guanidine site. In Table 4, the “Boundary Point ° C.” roughly represents the temperature at which the material transitions from a lower temperature sorption regime to a higher temperature sorption regime. In general, sites that readily adsorb CO₂ to create a less stable complex with less heat generation are beneficial in a cyclic adsorption process where heat management can constitute a major engineering challenge for rapid cycling.

TABLE 4
Dry Isobaric CO₂ Uptake Sorption-Temperature
Response Profiles for PIM-1-Derivatives.

| | | | | Higher Temp. | Lower Temp. |
|---|---|---|---|---|---|
| | | Higher Temp. | Lower Temp. | Regime | Regime |
| | | Regime | Regime | Response | Response |
| | | Response | Response | (mmol | (mmol |
| | | (mmol | (mmol | CO₂/mmol | CO₂/mmol |
| | Boundary | CO₂/g | CO₂/g | functional | functional |
| Material | Point ° C. | sorbent • ° C.) | sorbent • ° C.) | groups • ° C.) | groups • ° C.) |
| PIM-1- | 61 | 0.0130 | 0.026 | 0.0036 | 0.0071 |
| guan100 | | | | | |
| PIM-1- | 72 | 0.0086 | 0.046 | 0.0020 | 0.0109 |
| amine | | | | | |
| PIM-1 | 61 | 0.0068 | 0.021 | NA | NA |

### Example 7—Demonstration of Basicity Function of Guanidine Substituents

Material PIM-1-guan100 was further compared to its di-HCl salt, PIM-1-guan 100·HCl, based on dry isobaric CO₂ sorption at 100 kPa and breakthrough at 35° C. with 4.5% CO₂ in He. PIM-1-guan100·HCl corresponds to an acid neutralized version of PIM-1-guan 100. PIM-1-guan 100·HCl has its strong Brønsted base sites deactivated by formation of guanidinium hydrochlorides, unlike the free guanidinyl base in PIM-1-guan100. As a result, PIM-1-guan 100·HCl is not expected to show strong interactions with CO₂. As demonstrated in FIG. 14, the isobaric uptake of dry CO₂ by PIM-1-guan100-HCl is significantly lower than that for PIM-1-guan100 at all studied temperatures.

### Example 8—Further Demonstration of Strong Sorption Function of PIM-1-guan 100

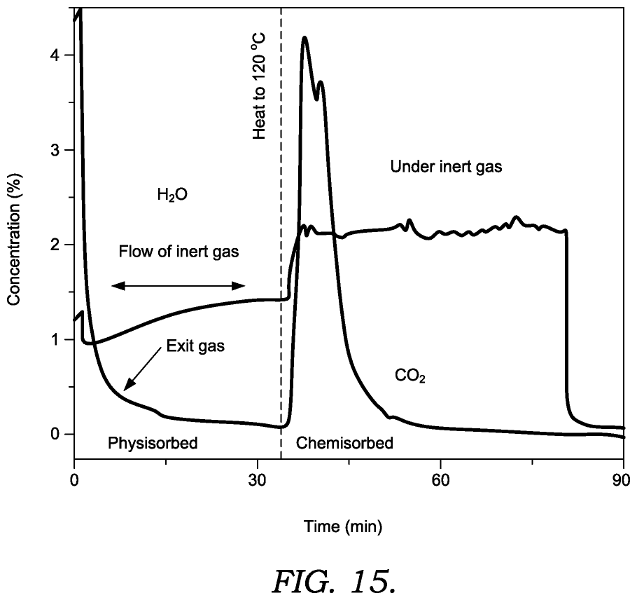

FIG. 15 shows a breakthrough plot of PIM-1-guan 100. In this experiment, the PIM-1-guan. 100 sample was placed in the breakthrough unit sample bed and dried at 120° C. under argon for 1 hour. The bed of the breakthrough unit was saturated with humidified argon (50% relative humidity) until a full H₂O breakthrough profile was seen at 30° C., approximately 2 hours. The unit gas feed was then switched to a humidified inert gas feed (50% relative humidity) containing 4.5% CO₂. The gas streams were humidified by passage through a bubbler at room temperature (21-23° C.). After adsorption at 30-35° C., inert gas was then passed through the CO₂- and H₂O-saturated sample bed. The sample was first exposed to inert gas flow at 35° C. (left side of plot, to left of dotted line) to desorb weakly sorbed (physisorbed) gas. Negligible CO₂ is released (curve indicated by “exit gas” arrow dropping to 0, representing gas flowing out of sample chamber exit to a mass spectrometer measuring the % of CO₂ in the exit gas). Simultaneously, water in the sample is released and continues to be released throughout the experiment. When the sample is then heated to 120° C. under inert gas flow to release strongly sorbed (chemisorbed) gas (right side of plot, to right of dotted line), the CO₂ concentration in the exit gas immediately rises, then quickly falls back to zero indicating facile, quick, complete thermal desorption. Such behavior is advantageous for achieving a rapid temperature-swing adsorption cycle. By having a sharp profile for desorption, the amount of sweep gas needed to facilitate substantially full desorption of a sorbent can be reduced or minimized. A rapid sorption/desorption cycle time further enables use of a smaller adsorbent inventory and a smaller reactor system to heat and cool. The result is lower CAPEX and OPEX cost of the process.

### Example 9—Humid CO₂ Sorption of Guandinylated PIM-1-Derivatives

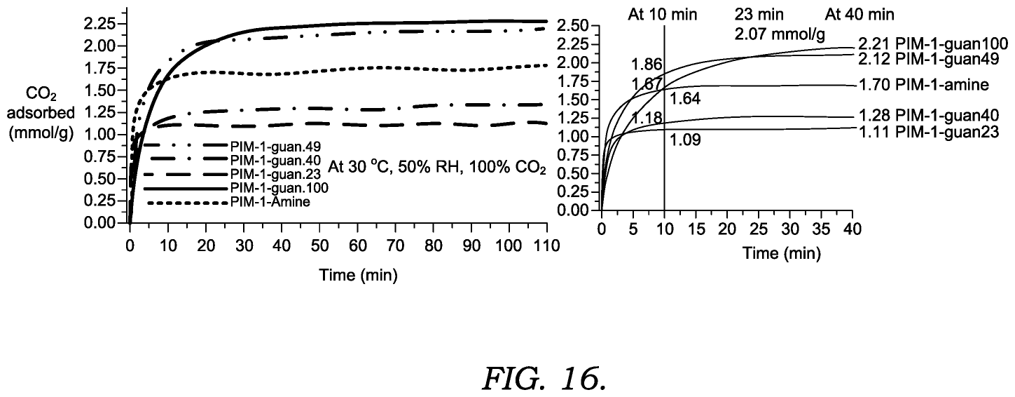

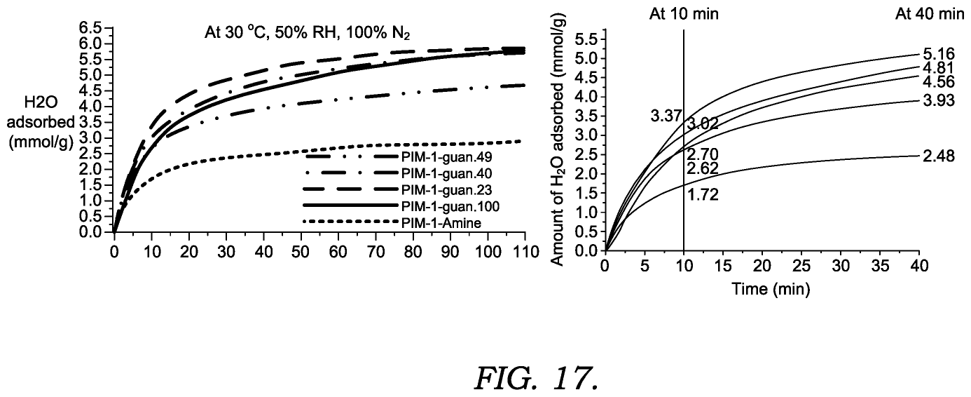

FIG. 16 and FIG. 17 show TGA CO₂ and H₂O adsorption, respectively, for the PIM-1-derivatives and comparatives of Table 1 taken under conditions of CO₂ with 50% relative humidity at 30° C. Uptake values at time=10 and 40 minutes are summarized in Table 5. The two samples with the highest guanidine content, PIM-1-guan49 and PIM-1-guan100, have the greatest overall CO₂ uptake. “Mixed base” sample PIM-1-guan49, with a near 1:1 guanidine:amine molar composition, provides near-comparable CO₂ uptake to PIM-1-guan100, but with much faster initial kinetics (larger upward line slope at very short uptake times in FIG. 16). This faster uptake is advantageous for enabling a sorption process with a shorter cycle time.

TABLE 5
Humid CO₂ Uptake for PIM-1-Derivatives at 30° C. and 50% Relative
Humidity.

| | CO₂ | | | | H₂O | | | | | |
|---|---|---|---|---|---|---|---|---|---|---|
| | 10 min | 10 min | 40 min | 40 min | 10 min | 10 min | 40 min | 40 min | CO₂:H₂O Molar | |
| | Uptake, | molar | Uptake, | molar | Uptake, | molar | Uptake, | molar | Uptake Ratio | |
| Material | mmol/g | efficy. | mmol/g | efficy. | mmol/g | efficy. | mmol/g | efficy. | 10 min | 40 min |
| PIM-1- | 1.64 | 0.384 | 1.70 | 0.398 | 1.72 | 0.403 | 2.48 | 0.581 | 0.95 | 0.69 |
| amine | | | | | | | | | | |
| PIM-1- | 1.09 | 0.266 | 1.11 | 0.271 | 3.37 | 0.822 | 5.16 | 1.259 | 0.32 | 0.22 |
| guan23 | | | | | | | | | | |
| PIM-1- | 1.18 | 0.296 | 1.28 | 0.322 | 3.02 | 0.759 | 4.81 | 1.209 | 0.39 | 0.26 |
| guan40 | | | | | | | | | | |
| PIM-1- | 1.86 | 0.476 | 2.12 | 0.542 | 2.62 | 0.670 | 3.93 | 1.005 | 0.71 | 0.54 |
| guan49 | | | | | | | | | | |
| PIM-1- | 1.67 | 0.461 | 2.21 | 0.610 | 2.70 | 0.746 | 4.56 | 1.260 | 0.62 | 0.49 |
| guan100 | | | | | | | | | | |

### Example 10—Humid CO₂ Sorption of PIM-1-guan 100 at 35° C.

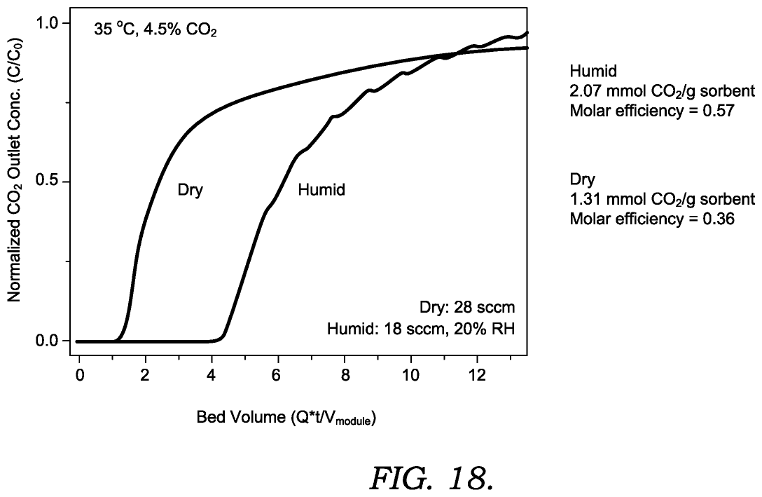

FIG. 18 shows sorption breakthrough of 4.5 kPa Partial Pressure of CO₂ in He by PIM-1-guan 100 at 35° C. and 20% relative humidity. For comparison, sorption breakthrough at similar conditions but with unhumidified CO₂ (dry conditions) is also shown. Sorption breakthrough does not indicate a total sorption capacity. Instead, sorption breakthrough shows the amount of capacity that can be accessed during a sorption cycle before a substantial amount of CO₂ “breaks through” and remains in the exhaust gas flow from the sorbent environment. To obtain a total amount of CO₂ sorbed I mmol/g sorbent, the area between the He and CO₂ breakthrough curves is calculated and multiplied by the molar fraction of CO₂ in the feed. The CO₂ sorption breakthrough behavior of PIM-1-guan100 is improved under humid conditions (2.07 mmol CO₂/g sorbent and 0.57 mmol CO₂/mmol amine/guanidinyl) as compared to dry conditions (1.31 mmol CO₂/g sorbent and 0.36 mmol CO₂/mmol amine/guanidinyl). Improved sorption in the presence of water means that CO₂ can be sorbed from a flue gas without having to first perform separation to remove at least some of the water from the flue gas.

In some aspects, the benefits of having water present in a gas where CO₂ is being sorbed can be achieved for relative humidity values of 5.0% or higher, or 15% or higher, such as up to 100% relative humidity. In some aspects, the relative humidity can be 5.0% to 95%, or 5.0% to 50%, or 50% to 95%.

In some aspects, the CO₂ concentration in a gas where CO₂ is being sorbed can be 30 vol % or less, or 20 vol % or less, or 10 vol % or less. For example, the CO₂ concentration can be 0.02 vol % (i.e, 200 vppm) to 30 vol %, or 0.02 vol % to 20 vol %, or 0.02 vol % to 10 vol %, or 0.02 vol % to 6.0 vol %, or 1.0 vol % to 30 vol %, or 1.0 vol % to 20 vol % or 1.0 vol % to 10 vol %, or 1.0 vol % to 6.0 vol %, or 5.0 vol % to 30 vol %, or 5.0 vol % to 20 vol %, or 8.0 vol % to 30 vol %.

### Additional Embodiments

Embodiment 1. A composition comprising a polymer comprising repeat units having a backbone structure of a polymer of intrinsic microporosity, wherein at least a portion of the repeat units have a substituent attached to the backbone structure comprising a guanidine derivative, the guanidine derivative optionally comprising a guanidinyl functional group.
Embodiment 2. The composition of Embodiment 1, wherein 10% or more of the repeat units have a substituent attached to the backbone structure comprising a guanidine derivative.
Embodiment 3. The composition of Embodiment 1 or 2, wherein at least a portion of the repeat units have a substituent attached to the backbone structure comprising an amine but not comprising a guanidine derivative, the composition optionally having 10% or more of the repeat units that have a substituent attached to the backbone structure comprising an amine but not comprising a guanidine derivative.
Embodiment 4. The composition of Embodiment 3, wherein the substituent attached to the backbone structure comprising an amine comprises an aminomethyl group.
Embodiment 5. The composition of any of the above embodiments, wherein the repeat units have a backbone structure comprising PIM-1, Py-PIM, or a combination thereof.
Embodiment 6. The composition of any of the above embodiments, wherein the guanidine derivative is separated from the backbone structure by at least one aliphatic carbon.
Embodiment 7. The composition of any of the above embodiments, wherein 70% or more of the repeat units comprise a substituent comprising a guanidine derivative; or wherein 30% to 70% of the repeat units comprise a substituent comprising a guanidine derivative; or wherein 40% to 60% of the repeat units comprise a substituent comprising a guanidine derivative; or wherein 10% to 30% of the repeat units comprise a substituent comprising a guanidine derivative.
Embodiment 8. The composition of any of the above embodiments, wherein the composition has a surface area that is lower than the surface area of a polymer comprising unsubstituted repeat units of the polymer of intrinsic microporosity.
Embodiment 9. A method for sorbing CO₂, comprising: exposing a polymer comprising repeat units having a backbone structure of a polymer of intrinsic microporosity to a gas phase environment comprising CO₂, wherein at least a portion of the repeat units have a substituent attached to the backbone structure comprising a guanidine derivative.
Embodiment 10. The method of Embodiment 9, wherein the gas phase environment comprises a relative humidity of 5.0% to 95% and 30 vol % or less of CO₂.
Embodiment 11. The method of Embodiment 9 or 10, wherein the gas phase environment comprises 6.0 vol % or less of CO₂, or wherein the gas phase environment comprises 13 kPa or less of CO₂, or a combination thereof.
Embodiment 12. The method of Embodiment 9, wherein the gas phase environment comprises a relative humidity of 50% or less, or wherein the gas phase environment comprises 10 vol % or more of CO₂, or a combination thereof.
Embodiment 13. The method of any of Embodiments 9-12, wherein the exposing the polymer forms a sorption-enriched polymer comprising sorbed CO₂, the method further comprising exposing the sorption-enriched polymer to a second gas phase environment to form a CO₂-depleted polymer, the exposing the polymer and the exposing the sorption-enriched polymer optionally comprising a cyclic process.
Embodiment 14. The method of Embodiment 13, wherein exposing the sorption-enriched polymer to the second gas phase environment comprises i) exposing the sorption-enriched polymer to an environment comprising a lower partial pressure of CO₂ than a partial pressure of CO₂ in the gas phase environment; ii) exposing the sorption-enriched polymer to a lower total pressure than a total pressure during the exposing the polymer; iii) exposing the sorption-enriched polymer to a higher temperature than a temperature during the exposing the polymer; or iv) a combination of two or more thereof.
Embodiment 15. The method of Embodiment 14, wherein exposing the sorption-enriched polymer to a lower pressure comprises exposing the sorption-enriched polymer to a total pressure of 20 kPa-a or less.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A composition comprising a polymer comprising repeat units having a backbone structure of a polymer of intrinsic microporosity, wherein at least a portion of the repeat units have a substituent attached to the backbone structure comprising a guanidine derivative, an amidine derivative, or a combination thereof.

2. The composition of claim 1, wherein 10% or more of the repeat units have a substituent attached to the backbone structure comprising a guanidine derivative.

3. The composition of claim 2, wherein at least a portion of the repeat units have a substituent attached to the backbone structure comprising an amine but not comprising a guanidine derivative.

4. The composition of claim 3, wherein 10% or more of the repeat units have a substituent attached to the backbone structure comprising an amine but not comprising a guanidine derivative.

5. The composition of claim 3, wherein the substituent attached to the backbone structure comprising an amine comprises an aminomethyl group.

6. The composition of claim 1, wherein the repeat units have a backbone structure comprising PIM-1, Py-PIM, or a combination thereof.

7. The composition of claim 1, wherein the guanidine derivative is separated from the backbone structure by at least one aliphatic carbon.

8. The composition of claim 1, wherein the guanidine derivative comprises a guanidinyl functional group.

9. The composition of claim 1, wherein 70% or more of the repeat units comprise a substituent comprising a guanidine derivative.

10. The composition of claim 1, wherein 30% to 70% of the repeat units comprise a substituent comprising a guanidine derivative.

11. The composition of claim 1, wherein 40% to 60% of the repeat units comprise a substituent comprising a guanidine derivative.

12. The composition of claim 1, wherein 10% to 30% of the repeat units comprise a substituent comprising a guanidine derivative.

13. The composition of claim 1, wherein the composition has a surface area that is lower than the surface area of a polymer comprising unsubstituted repeat units of the polymer of intrinsic microporosity.

14. The composition of claim 1, wherein 10% or more of the repeat units have a substituent attached to the backbone structure comprising an amidine derivative.

15. The composition of claim 14, wherein at least a portion of the repeat units have a substituent attached to the backbone structure comprising an amine but not comprising an amidine derivative.

16. The composition of claim 1, wherein the amidine derivative is separated from the backbone structure by at least one aliphatic carbon.

17. A method for sorbing CO₂, comprising:
exposing a polymer comprising repeat units having a backbone structure of a polymer of intrinsic microporosity to a gas phase environment comprising CO₂, wherein at least a portion of the repeat units have a substituent attached to the backbone structure comprising a guanidine derivative.

18. The method of claim 17, wherein the gas phase environment comprises a relative humidity of 5.0% to 95% and 30 vol % or less of CO₂.

19. The method of claim 17, wherein the gas phase environment comprises 6.0 vol % or less of CO₂, or wherein the gas phase environment comprises 13 kPa or less of CO₂, or a combination thereof.

20. The method of claim 17, wherein the gas phase environment comprises a relative humidity of 50% or less, or wherein the gas phase environment comprises 10 vol % or more of CO₂, or a combination thereof.

21. The method of claim 17, wherein the exposing the polymer forms a sorption-enriched polymer comprising sorbed CO₂, the method further comprising exposing the sorption-enriched polymer to a second gas phase environment to form a CO₂-depleted polymer, the exposing the polymer and the exposing the sorption-enriched polymer optionally comprising a cyclic process.

22. The method of claim 17, wherein exposing the sorption-enriched polymer to the second gas phase environment comprises exposing the sorption-enriched polymer to an environment comprising a lower partial pressure of CO₂ than a partial pressure of CO₂ in the gas phase environment.

23. The method of claim 17, wherein exposing the sorption-enriched polymer to the second gas phase environment comprises i) exposing the sorption-enriched polymer to a lower total pressure than a total pressure during the exposing the polymer; ii) exposing the sorption-enriched polymer to a total pressure of 80 kPa-a or less; iii) exposing the sorption-enriched polymer to a higher temperature than a temperature during the exposing the polymer; or iv) a combination of two or more of i), ii) and iii).

24. The method of claim 23, wherein exposing the sorption-enriched polymer to a lower pressure comprises exposing the sorption-enriched polymer to a total pressure of 20 kPa-a or less.
